(19) United States
(12) Patent Application Publication
(10) Pub. No.: US 2002/0107025 A1
(43) Pub. Date: Aug. 8, 2002

(54) System and method for service-based resource allocation

(75) Inventor: Fernando De Oliveira, St-Laurent (CA)

Correspondence Address: ERICSSON RESEARCH CANADA, 8400 DECARIE BLVD., MONTREAL, QC, H4P 2N2, CA

(73) Assignee: Telefonaktiebolaget LM Ericsson (publ)

(21) Appl. No.: 09/781,532

(22) Filed: Feb. 8, 2001

(51) Int. Cl. H04Q 7/20

(52) U.S. Cl. 455/452; 455/458; 455/512; 455/435

(57) ABSTRACT

A system and method for allocating network resources in a cellular telecommunications network to perform a requested service. A capabilities database stores information identifying each particular cell's capability to provide each of a plurality of services. A processor compares the requested service to the information stored in the capabilities database for each cell in order to determine each cell's capability to provide the requested service. A modified cell list is built by eliminating those cells that cannot provide the requested service. A resource controller then allocates network resources only in the cells that can provide the requested service.

### BACKGROUND OF THE INVENTION

1. Technical Field of the Invention

This invention relates to telecommunication systems and, more particularly, to a system and method for allocating network resources in a cellular telecommunications network based upon the type of service being requested.

2. Description of Related Art

Certain subscriber services in a cellular telecommunications network can be specified by the network operator on a per-cell basis. That is, a particular service may be offered in some cells in an exchange while the service is not offered in other cells. Additionally, when a new service is being implemented, the operator may upgrade the network one base station at a time. In this case, some cells may be capable of providing the new service while others are not. Many of the resource allocation procedures currently utilized in cellular telecommunications networks do not consider whether a particular cell is capable of supporting a particular type of service before allocating network resources. Thus, in many cases, network resources are unnecessarily utilized in cells that cannot provide the service being requested.

A good example of the inefficient use of network resources is illustrated by the current paging process. Currently, when paging for a mobile station, the paging process first pages for the mobile station in a group of cells known as a location area (LA). The LA generally includes the cell where the mobile station was last reported to be operating. If the mobile station is not found in the LA, the search is broadened, and the mobile station is paged in a paging area (PA) which is a group of LAs. Finally, if the mobile station is still not found in the PA, the mobile station is paged throughout the entire service area (SA) of the exchange. This process is described in U.S. Pat. No. 5,369,681 to Boudreau et al. All of the cells in each type of area are paged at each step, regardless of each cell's capability to provide the type of service requested. For example, the incoming call may be a G3 Fax call, and all of the cells are paged, even those that are not capable of providing G3 Fax service. This is an inefficient use of paging resources.

It would be advantageous to have a more efficient system and method for allocating network resources. The present invention provides such a system and method.

### SUMMARY OF THE INVENTION

In one aspect, the present invention is an efficient method of allocating network resources that considers each cell's capability to provide a requested service prior to allocating network resources in each cell. The method includes the steps of determining each particular cell's capability to provide the requested service prior to allocating network resources in that cell, and allocating network resources only in the cells that can provide the requested service. In a handoff embodiment, a list of candidate cells for handoff is screened so that only cells capable of handling the type of call being handed off are included on the list. This ensures that resources are not utilized to hand off a call to a cell that cannot handle that call type.

In another embodiment, the network resources are paging resources for paging a mobile station, and the step of determining each particular cell's capability to provide the requested service includes determining the capability of each particular cell in a location area (LA) to provide the requested service. A modified cell list is built by eliminating those cells that are not capable of providing the requested service. The method then pages for the mobile station only in the cells of the LA that can provide the requested service.

If the mobile station does not respond to the paging in the LA, a cell list for a paging area (PA) is built that comprises only cells that can provide the requested service. The mobile station is then paged only in the cells of the PA that can provide the requested service. If the mobile station does not respond to the paging in the PA, a cell list for a service area (SA) is built that comprises only cells that can provide the requested service. The mobile station is then paged only in the cells of the SA that can provide the requested service.

In another aspect, the present invention is a system for allocating network resources in a cellular telecommunications network to perform a requested service. The system includes a capabilities database that stores information identifying each particular cell's capability to provide each of a plurality of services. A processor compares the requested service to the information stored in the capabilities database for each cell in order to determine each cell's capability to provide the requested service. A resource controller then allocates network resources only in the cells that can provide the requested service.

In an embodiment in which the network resources are paging resources, the processor builds a cell list for the LA where a mobile station is to be paged. The cell list includes only cells that can provide the requested service. A paging mechanism retrieves the cell list for the LA from the cell list database and pages for the mobile station only in the cells of the LA that can provide the requested service. If the mobile station does not respond to the paging in the LA, the processor builds a cell list for a PA that comprises only cells that can provide the requested service. The paging mechanism then pages for the mobile station only in the cells of the PA that can provide the requested service. If the mobile station does not respond to the paging in the PA, the processor builds a cell list for an SA that comprises only cells that can provide the requested service. The paging mechanism then pages for the mobile station only in the cells of the SA that can provide the requested service.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a high level flowchart illustrating the method of the present invention when allocating network resources;

FIGS. 2A-2C are portions of a flowchart illustrating how the method of the present invention allocates paging resources when a page request for a mobile station is issued; and

FIG. 3 is a simplified block diagram of a system for performing the method of FIGS. 2A-2C.

### DETAILED DESCRIPTION OF EMBODIMENTS

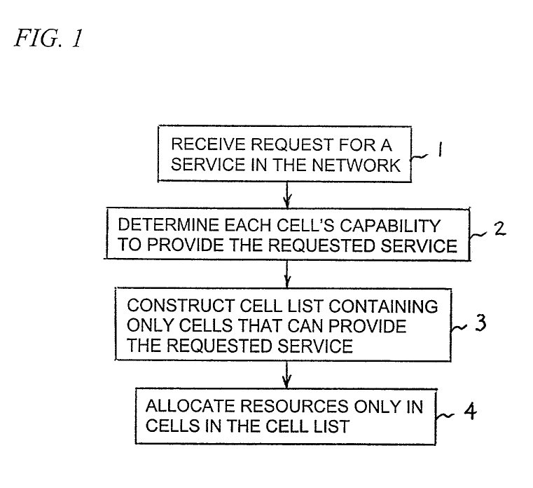

FIG. 1 is a high level flowchart illustrating the method of the present invention when allocating network resources. The present invention efficiently allocates network resources by considering each particular cell's capability to provide a requested service prior to allocating network resources in that cell. Anytime a cell list is constructed for any purpose in the network, the list is screened to make sure that only cells are included that provide the necessary services. The invention, therefore, is broadly applicable to any type of service area, as long as the requested service is used to screen the cell list so that network resources are utilized only in cells that provide the requested service.

At step 1, a request for a particular service is received in a cellular network. At step 2, the network determines each cell's capability to provide the requested service. At step 3, a cell list is constructed containing only the cells that can provide the requested service. At step 4, the network allocates resources only in the cells in the cell list, or in a particular selected cell from the cell list, thereby ensuring that network resources are utilized only in cells that can provide the requested service.

For example, when a mobile station is performing signal strength measurements of neighboring cells, it creates a list of candidate cells for handoff known as a Mobile Assisted Handoff (MAHO) list. In accordance with the present invention, if the mobile station is conducting, for example a G3 Fax call, and a neighboring cell does not support the G3 Fax service, the mobile station eliminates that neighboring cell from the MAHO list. In this way, only cells capable of supporting the requested service are considered for allocation of network resources.

The preferred embodiment of the present invention is described in the context of the allocation of paging resources. The present invention analyzes the service being requested, and removes cells from the list of cells to be paged that are not capable of providing the requested service.

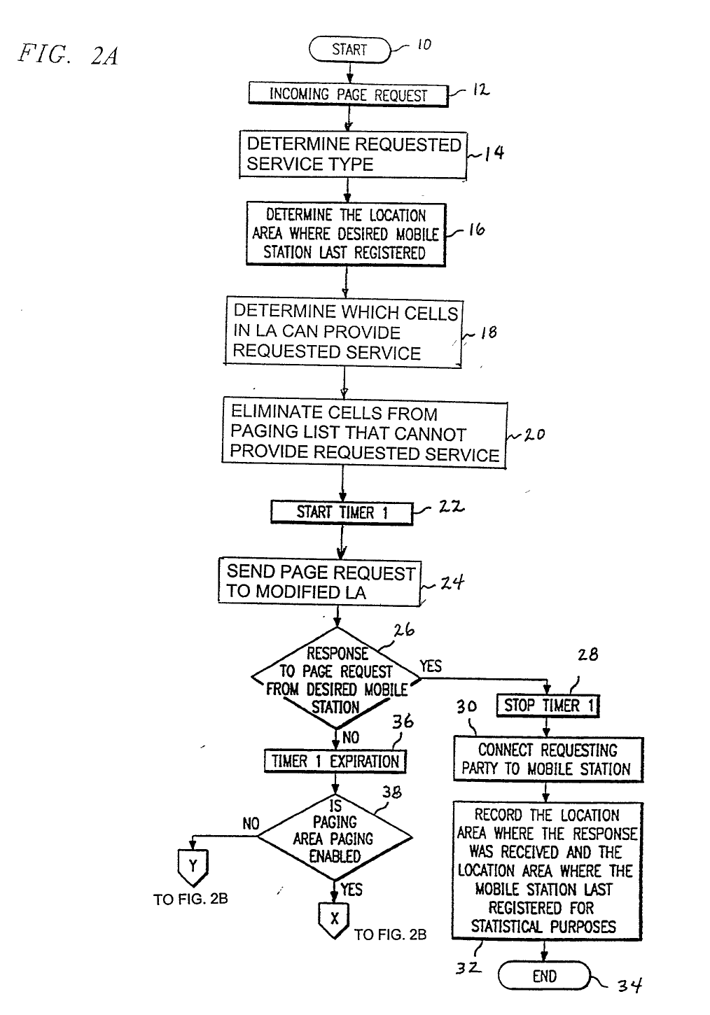

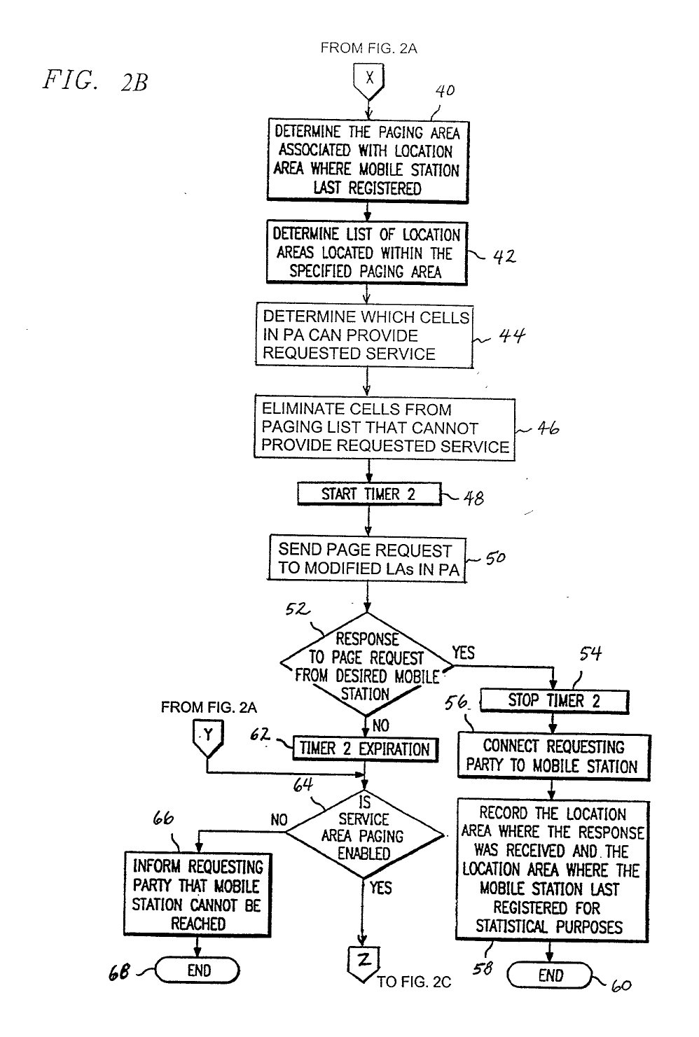

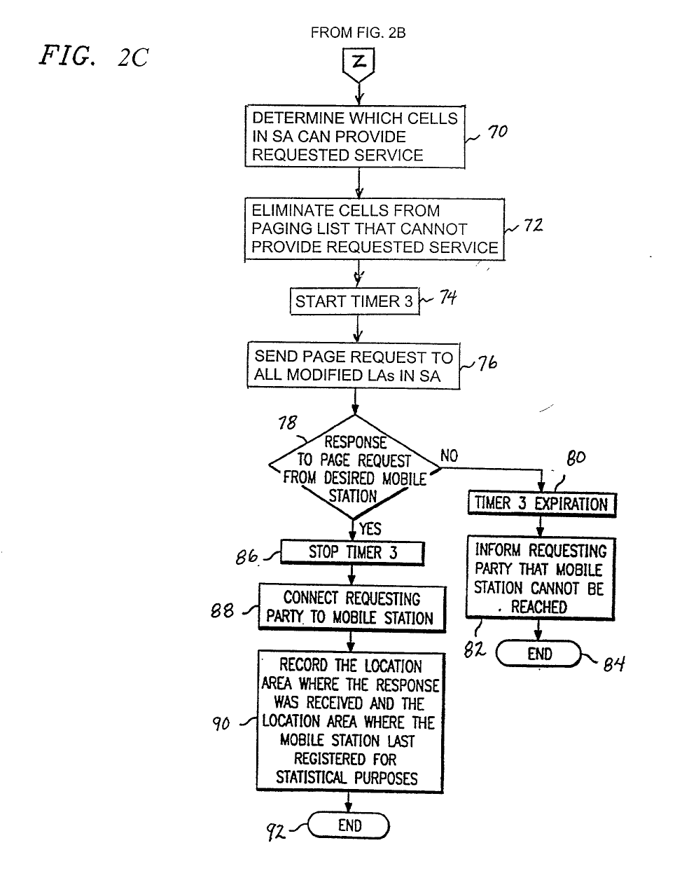

FIGS. 2A-2C are portions of a flowchart illustrating how the method of the present invention allocates paging resources when a page request for a mobile station is issued. The process begins at 10, and at step 12 an incoming page request is accepted, or a new page is issued, in a Mobile Switching Center (MSC). At step 14, the MSC determines the requested service type which may be identified by a service type parameter in a Routing Request or Call Origination message. Thereafter, at 16 the MSC or Base Station Controller (BSC) recalls from its memory the location area (LA) where the desired mobile station last registered. If the mobile station is inactive, this information may be retrieved from the mobile subscriber's Home Location Register (HLR). At step 18, the MSC determines from a capabilities (configuration) database, which cells in the LA can provide the requested service. Those cells that cannot provide the requested service are eliminated from the paging list at 20.

At step 22, a first timer is started to establish a maximum time period for a page response to be received from the mobile station. At 24, the MSC sends a page request to the modified LA where the mobile station last registered, and the mobile station is paged only in the cells that are capable of providing the requested service. At 26 it is determined whether a page response has been received from the desired mobile station. If a page response has been received, the method proceeds to step 28 where the first timer is stopped. Next, at 30 the mobile station is connected to the requesting calling party. Thereafter, at 32 the network may record the identity of the LA from which the response was received and the identity of the LA where the mobile station last registered for statistical purposes. The statistics may be utilized in further optimizing coverage of location areas and paging areas. The paging process then ends at 34.

If, however, at step 26 a page response is not received from the mobile station, the method proceeds to step 36 where the first timer expires. Next, at 38 it is determined whether or not paging area (PA) paging has been enabled. If PA paging has not been enabled, the method proceeds to step 64 of FIG. 2B where it is determined whether or not service area (SA) paging is enabled for the system. If SA paging has not been enabled, the calling party is informed at 66 that the mobile station cannot be reached. The paging process then ends at 68.

If, however, at 38 it is determined that PA paging has been enabled, the method proceeds to step 40 of FIG. 2B where the MSC or BSC retrieves from its memory the paging area parameters associated with the location area where the mobile station last registered. Next, at 42 a list of the particular location areas defined by the specified paging area parameters is retrieved. At step 44, the MSC determines which cells in the PA can provide the requested service. Those cells that cannot provide the requested service are eliminated from the paging list at 46. Thereafter, at 48, a second timer is started to establish a maximum time period to receive a page response from the mobile station. At 50, the MSC sends a page request to each of the modified LAs within the defined PA, and the mobile station is paged only in the cells that are capable of providing the requested service. At 52, it is determined whether a page response has been received from the desired mobile station. If so, the second timer is stopped at 54; thereafter, the calling party is connected at 56 to the desired mobile station. At 58 the network may record the LA from which a page response was received and where the mobile station last registered for statistical purposes. The paging process then ends at 60.

If at 52, the page response is not received from the desired mobile station, the second timer expires at 62. At 64, it is then determined whether service area (SA) paging has been enabled. If SA paging has not been enabled, the method proceeds to 66 where the calling party is informed that the mobile station cannot be reached. The paging process then ends at 68.

If at 64, SA paging has been enabled for the system, then the method moves to step 70 of FIG. 2C where the MSC determines which cells in the SA can provide the requested service. Those cells that cannot provide the requested service are eliminated from the paging list at 72. Thereafter at 74, a third timer is started to establish a maximum time period to receive a page response from the mobile station. Thereafter, at 76 the MSC sends page requests to all of the modified LAs within the SA, and the mobile station is paged only in the cells that are capable of providing the requested service. At 78, it is determined whether a page response has been received from the desired mobile station. If, a page response is not received from the desired mobile station, the third timer expires at 80. Next, at 82 the calling party is informed that the desired mobile station cannot be reached. The paging process then ends at 84.

If a page response is received from the mobile station at 78, the third timer is stopped at 86. Next, at 88 the calling party is connected to the desired mobile station; and at 90, the network may record the LA from which the response was received and where the mobile station last registered for statistical purposes. The paging process then ends at 92.

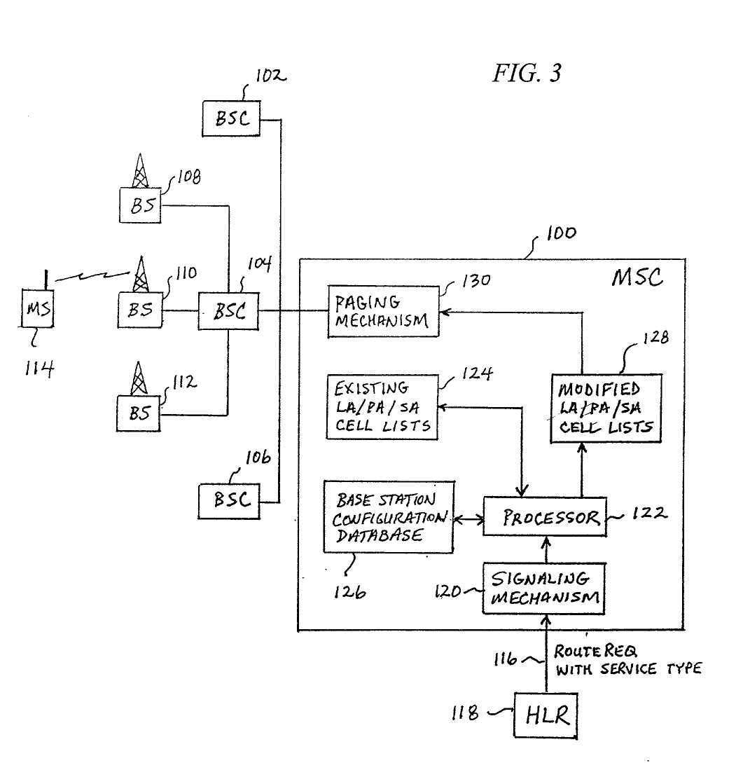

FIG. 3 is a simplified block diagram of a system for performing the method of FIGS. 2A-2C. An MSC 100 may control a plurality of BSCs such as BSCs 102, 104, and 106. Each of the BSCs, in turn, may control a plurality of base stations (BSs) such as BSs 108, 110, and 112 controlled by BSC 104. The MSC and the BSCs control network resource allocations. A called mobile station (MS) 114 is operating within the service area of the MSC 100.

The MSC 100 may receive a request to page for the MS 114 in a call origination message from another MS operating in the MSC's service area, or in a Routing Request (ROUTEREQ) Invoke message 116 from a Home Location Register (HLR) 118. In either case, in the present invention, the incoming message includes an indication of the requested service type. The message is received in a signaling mechanism 120 which passes it to a processor 122. The processor determines the requested service type and determines which LA should be paged to locate the MS.

The processor retrieves an existing cell list for the LA from a cell list database 124, and retrieves BS capabilities data from a base station configuration database 126. The processor then determines which cells in the LA are capable of providing the requested service. Cells that are not capable of providing the requested service are eliminated from the LA cell list, and a modified LA cell list is built and stored in database 128. The modified LA cell list, containing only cells that are capable of providing the requested service, is then sent to a paging mechanism 130. The paging mechanism sends page requests to the appropriate BSC(s), and the mobile station is paged only in the cells that are capable of providing the requested service. Although the embodiment shown herein illustrates the processor 122 and various databases 124, 126, and 128 in the MSC, it should be recognized that some or all of these functions may be implemented elsewhere in the cellular network such as in the BSC, in a Network Management System (NMS), or in a stand-alone paging controller.

In accordance with the method shown in FIGS. 2A-2C, if the MS does not respond to the page attempt within the LA, an attempt is made in a paging area (PA). Once again, the processor retrieves an existing cell list for the PA from the cell list database 124, and retrieves BS capabilities data from the base station configuration database 126. The processor then determines which cells in the PA are capable of providing the requested service. Cells that are not capable of providing the requested service are eliminated from the PA cell list, and a modified PA cell list is built and stored in database 128. The modified PA cell list, containing only cells that are capable of providing the requested service, is then sent to the paging mechanism 130, and the mobile station is paged only in the cells that are capable of providing the requested service. If paging is unsuccessful at the PA level, the same process is performed at the SA level.

It is thus believed that the operation and construction of the present invention will be apparent from the foregoing description. While the method, apparatus and system shown and described has been characterized as being preferred, it will be readily apparent that various changes and modifications could be made therein without departing from the scope of the invention as defined in the following claims.

What is claimed is:

1. A method in a cellular telecommunications network of constructing a list of cells comprising at least one cell in which network resources are to be allocated to perform a requested service, said method comprising the steps of:
determining each particular cell's capability to provide the requested service; and
building a cell list comprising only cells that can provide the requested service.

2. A method in a cellular telecommunications network of allocating network resources to perform a requested service, said method comprising the steps of:
determining each particular cell's capability to provide the requested service prior to allocating network resources in that cell; and
allocating network resources only in the cells that can provide the requested service.

3. The method of allocating network resources of claim 2 further comprising, before the step of allocating network resources, the step of building a cell list comprising only cells that can provide the requested service.

4. The method of allocating network resources of claim 3 wherein the network resources are paging resources for paging a mobile station, and the step of determining each particular cell's capability to provide the requested service includes determining the capability of each particular cell in a location area (LA) to provide the requested service.

5. The method of allocating network resources of claim 4 further comprising paging for the mobile station only in the cells of the LA that can provide the requested service.

6. The method of allocating network resources of claim 5 further comprising the steps of:
determining that the mobile station did not respond to the paging in the LA;
building a cell list for a paging area (PA) comprising only cells that can provide the requested service; and
paging for the mobile station only in the cells of the PA that can provide the requested service.

7. The method of allocating network resources of claim 6 further comprising the steps of:
determining that the mobile station did not respond to the paging in the PA;
building a cell list for a service area (SA) comprising only cells that can provide the requested service; and
paging for the mobile station only in the cells of the SA that can provide the requested service.

8. A system for constructing a list of cells comprising at least one cell in which network resources are to be allocated to perform a requested service, said system comprising:
a capabilities database that stores information identifying each particular cell's capability to provide each of a plurality of services;
a processor that compares the requested service to the information stored in the capabilities database for each cell in order to determine each cell's capability to provide the requested service; and
a resource controller that builds a cell list comprising only cells that can provide the requested service.

9. A system for allocating network resources in a cellular telecommunications network to perform a requested service, said system comprising:
a capabilities database that stores information identifying each particular cell's capability to provide each of a plurality of services;
a processor that compares the requested service to the information stored in the capabilities database for each cell in order to determine each cell's capability to provide the requested service; and
a resource controller that allocates network resources only in the cells that can provide the requested service.

10. The system for allocating network resources of claim 9 wherein the network resources are paging resources for paging a mobile station, and the capabilities database stores information identifying the capability of each particular cell in a location area (LA) to provide each of the plurality of services.

11. The system for allocating network resources of claim 10 wherein the processor compares the requested service to the information stored in the capabilities database for each cell in the LA in order to determine the capability of each cell in the LA to provide the requested service.

12. The system for allocating network resources of claim 11 further comprising a cell list database that stores cell lists comprised only of cells that can provide the requested service.

13. The system for allocating network resources of claim 12 wherein the cell list database includes:
a cell list comprised only of cells in the LA that can provide the requested service;
a cell list comprised only of cells in a paging area (PA) that can provide the requested service; and
a cell list comprised only of cells in a service area (SA) that can provide the requested service.

14. The system for allocating network resources of claim 13 further comprising a paging mechanism that retrieves the cell list for the LA from the cell list database and pages for the mobile station only in the cells of the LA that can provide the requested service.

15. The system for allocating network resources of claim 14 wherein the paging mechanism determines whether the mobile station responded to the paging in the LA, and if not, retrieves the cell list for the PA from the cell list database and pages for the mobile station only in the cells of the PA that can provide the requested service.

16. The system for allocating network resources of claim 15 wherein the paging mechanism determines whether the mobile station responded to the paging in the PA, and if not, retrieves the cell list for the SA from the cell list database and pages for the mobile station only in the cells of the SA that can provide the requested service.

17. The system for allocating network resources of claim 11 wherein the processor includes programming to compare the requested service to the information stored in the capabilities database for each cell in the network's service area in order to build a cell list for each LA in the service area, a cell list for each paging area (PA) in the service area, and a cell list for the entire service area, each of the cell lists comprising only cells that can provide the requested service.
